(19) United States
(12) Patent Application Publication
(10) Pub. No.: US 2025/0207025 A1
(43) Pub. Date: Jun. 26, 2025

(54) LIGHT-COLOURED PHOTOLUMINESCENT MATERIAL

(71) Applicant: The Swatch Group Research and Development Ltd, Marin (CH)

(72) Inventors: Nicolas FRANÇOIS, Neuchâtel (CH); Nathalie Teres, Bôle (CH)

(73) Assignee: The Swatch Group Research and Development Ltd, Marin (CH)

(21) Appl. No.: 18/918,648

(22) Filed: Oct. 17, 2024

(30) Foreign Application Priority Data
Dec. 21, 2023 (EP) 23219375.5

(51) Int. Cl. C09K 11/77; C08K 5/42; C08K 9/10; C09D 5/22; C09D 7/40; C09D 7/62; C09D 7/63; C09K 11/02

(52) U.S. Cl. CPC C09K 11/7792; C09D 5/22; C09D 7/62; C09D 7/63; C09D 7/69; C09K 11/025; C08K 5/42; C08K 9/10; C08K 2201/005

(57) ABSTRACT

A photoluminescent material including, by weight, between 19.3% and 54.3% of a polymer matrix, between 45% and 80% of a photoluminescent compound, between 0.5% and 15% of a zirconium oxide, between 0.2% and 7% of an optical brightener and optionally between 0% and 5% of an aluminium oxide, between 0% and 0.3% of a porous silica, a dye system and additives, the total percentage of the dye system and additives being between 0% and 15%. Also, an item coated with this photoluminescent material or made as a whole from said photoluminescent material.

### CROSS REFERENCE TO RELATED APPLICATIONS

This application is claiming priority based on European Patent Application No. 23219375.5 filed on Dec. 21, 2023.

### TECHNICAL FIELD OF THE INVENTION

The invention relates to a light-coloured photoluminescent material with optimised luminous performance.

### TECHNOLOGICAL BACKGROUND

Europium and Dysprosium doped strontium aluminate phosphorescent pigments (Eu²⁺,Dy₃₊:SrAl₂O₄) are frequently used to make photoluminescent materials. These green or blue colour-emitting pigments often have a yellowish tinge, which makes it difficult to obtain certain light colours. Adding dopants such as calcium to the crystal lattice whitens the pigments, but this has a significant impact on luminous performance.

Certain compounds used in photoluminescent materials, including colouring pigments, have been noticed to have a quenching effect on the luminescent properties, the luminance of phosphorescent materials being the result of a physical-chemical interaction between the compounds of the photoluminescent material.

It is therefore difficult to jointly optimise colouration and luminous properties. In order to develop a formulation, the inventors of the present invention carried out tests with mineral compounds such as TiO₂, CaCO₃, ZnO, BaSO₄, SiO₂ and Al₂O₃ to whiten the luminescent material. The mineral compounds were added to an epoxy polymer matrix filled with 60 wt % of phosphorescent pigments of the type Europium- and Dysprosium-doped strontium aluminate (Eu²⁺,Dy₃₊:SrAl₂O₄). Tests have shown that these mineral compounds have a negative impact on luminous properties. An optimum must thus always be found between the colour perceived in daylight and photoluminescence.

### SUMMARY OF THE INVENTION

The invention consists of a novel formulation for white colours and, more typically, for light colours, allowing a beautiful light colour to be obtained under daylight while at the same time having good luminescent properties.

To this end, the invention proposes adding zirconium oxide (ZrO₂), more specifically stabilised zirconia and even more specifically yttria-stabilised zirconia at 4 or 5 mol %, an optical brightener and optionally aluminium oxide (Al₂O₃) to the formulation. This combination provides the best compromise between whiteness and luminous performance to combat the yellowish character of pigments derived from rare earth-doped alkaline-earth aluminate. The colour can then optionally be adjusted to lighter shades by adding a dye system.

More specifically, the invention relates to a photoluminescent material comprising, by weight, between 19.3% and 54.3% of a polymer matrix, between 45% and 80% of a photoluminescent compound, between 0.5% and 15% of a zirconium oxide, between 0.2% and 7% of an optical brightener and optionally between 0% and 2.5% of an aluminium oxide, between 0% and 0.3% of a porous silica, a dye system and additives, the total percentage of the dye system and additives being between 0% and 15%.

The optical brightener is useful for achieving a brilliant white. This is because it absorbs in the near UV visible range and re-emits in the blue range. In particular, it counteracts the yellowish aspect of the phosphorescent pigment.

If Al₂O₃ is added, the formulation can be whitened more intensely. Adding Al₂O₃ alone quenches luminescence too quickly. It must be used in combination with zirconia to avoid this problem.

Optionally, the photoluminescent material further comprises porous silica derived from algae to increase the luminous properties. The porous silica is derived from diatom skeletons. These are microalgae that are unicellular organisms with a silica skeleton. More specifically, according to the latest biological research, diatoms, the single-celled algae that make up plankton, are made up of silica nanocells that are highly efficient at absorbing daylight, even in the dark depths of the oceans, so that they can carry out photosynthesis efficiently. Adding a limited percentage of porous silica, with contents of less than or equal to one percent by mass, to the photoluminescent material improves the luminescence properties.

The invention further relates to the item produced as a whole from this photoluminescent material or coated with this photoluminescent material.

### DETAILED DESCRIPTION OF THE INVENTION

The invention relates to a photoluminescent material comprising zirconium oxide (ZrO₂). This material can be used to produce, as a whole, an item or to coat an item. The item can, for example, be a timepiece component. More specifically, it can be an external component chosen from the non-exhaustive list that includes a middle, a back, a bezel, a crown, a push-piece, a bracelet link, a bracelet, a tongue buckle, a clasp, a dial, a flange, a date disc, a hand and a dial index.

The photoluminescent material comprises (consists of) a polymer matrix, a photoluminescent compound, zirconium oxide, an optical brightener and optionally an aluminium oxide (Al₂O₃), a porous silica and a dye system and additives.

In relation to the total weight of the photoluminescent material, zirconium oxide in the form of stabilised zirconia, for example stabilised with 4 mol % or 5 mol % yttrium oxide, is present in a percentage by weight of between 0.5% and 15%, the percentage depending on the colour to be achieved. Preferably, it is present at between 1% and 10%. Typically, the particle size of the zirconia is submicron with a D50 of around 500 nm.

The polymer matrix is present in a percentage by weight of between 19.3% and 54.3%, preferably between 28.5% and 48.5%. It should be noted that the upper limit for the polymer matrix is calculated for a photoluminescent material without aluminium oxide, without porous silica and without a dye system and additives. In the presence of one of these compounds, the maximum limit will be reduced accordingly so as not to exceed a percentage of 100% for all of the compounds in the photoluminescent material. In the case of the polymer matrix, this can be any polymer that is transparent or semi-transparent in the visible range. By way of example, it can be one or more of the following polymers: resins from the acrylic family, the polyamide family, the polyolefin family, the epoxy family, the polyurethane family, the fluoroelastomer family and silicones.

The photoluminescent compound is present in a percentage by weight of between 45% and 80%, preferably between 50% and 70%. The photoluminescent compound can consist of a pigment or a pigment encapsulated in a transparent shell. The pigment is preferably a rare earth-doped alkaline earth aluminate derivative. More specifically, the pigment can be Europium and Dysprosium doped strontium aluminate with the formula Sr(x)Al(y)O(z):Eu²⁺,Dy₃₊. In particular, this can be Sr₄Al₁₄O₂₅:Eu²⁺,Dy₃₊ or SrAl₂O₄:Eu²⁺,Dy₃₊, optionally both present in the photoluminescent compound. Advantageously, the pigments can have different particle sizes to allow the pigments to be distributed optimally in the volume and avoid free spaces. The presence of different particle sizes in the volume also makes it possible to combine small particles forming shallow surface traps responsible for high light intensity over short periods with large particles forming deeper traps responsible for light remanence over long periods. By way of example, the pigments can have a first particle size range centred around a diameter D1 of between 500 nm and 10 μm, ideally between 500 nm and 5 μm, and a second particle size range centred around a diameter D2 of between 10 μm and 500 μm, ideally between 10 μm and 20 μm, with the particle size measured by laser particle size analysis to ISO 13320:2020, optionally supplemented by SEM analysis using secondary electron imaging. It should be noted that more than two particle size fractions can be sieved and then combined. For example, it is possible to have a 20 wt % of a first fraction between 500 nm and 5 μm, 60 wt % of a second fraction between 5 μm and 20 μm, and 20 wt % of a third fraction between 20 μm and 50 μm.

The pigments can optionally be encapsulated in a transparent organic or mineral shell. The organic shell can typically be chosen from the polymers mentioned for the polymer matrix. A mineral shell could, for example, be a silica (SiO₂) shell obtained using a sol-gel process. Other examples of mineral shells include zirconium oxide (ZrO₂), and aluminium oxide (Al₂O₃), etc.

The photoluminescent material further includes an optical brightener to give the material a white lustre. It is present in a percentage by weight of between 0.2% and 7%, preferably between 0.5% and 5%. The optical brighteners used are synthetic, organic molecules derived from stilbenes containing sulphonate groups which absorb between 300 nm and 400 nm and re-emit in the blue-violet range. They are mainly used in materials as whitening agents. Examples include distyrylbiphenyl (DSBP) and diaminostilbene derivatives.

Optionally, the photoluminescent material can comprise aluminium oxide (Al₂O₃) in a percentage by weight of between 0% and 5%, preferably between 0% and 2.5%, depending on the degree of whiteness desired. Advantageously, it comprises between 0.5% and 5% Al₂O₃, more advantageously between 0.5% and 3%.

The photoluminescent material optionally further comprises between 0 wt % and 15 wt %, preferably between 0.5 wt % and 8 wt % of a dye system and additives. Preferably, it comprises between 0.5 wt % and 5 wt % of a dye system. This system preferably comprises organic dyes which do not absorb in the emission wavelength ranges of the photoluminescent pigment. These can be fluorescent pigments or dyes whose absorption is more in the UV range and whose emission is in the visible spectrum. Examples include organic fluorescent pigments or dyes such as those by Radiant or Aralon®. They can also be translucent pigments or dyes with low absorption in the emission wavelengths of the phosphorescent pigment. Examples include translucent pigments or dyes by Clariant. Other additives can be added, such as metallic and pearlescent effect pigments, anti-UV additives to protect the polymer matrix, a dispersant such as silane to facilitate dispersion of the additives and a nanometric filler of the silica type to adapt the viscosity parameters of the mixture, etc.

Optionally, the photoluminescent material can comprise porous silica derived from diatom skeletons. Typically, the average pore diameter can be in the order of 500 μm. Optionally, it could be a synthetic porous silica. For a synthetic silica, the pores typically have an average diameter of between 0.1 μm and 3 μm. The porous silica is present in a percentage by weight of between 0% and 0.3%, preferably between 0.01% and 1%, more preferably between 0.07% and 0.3%, and even more preferably between 0.09% and 0.2%.

The method for manufacturing an item produced as a whole from the photoluminescent material involves mixing the one or more polymers intended to form the polymer matrix with, preferably, a dispersant. This initial mixing is carried out with the photoluminescent pigments, which optionally may have been encapsulated beforehand. Zirconium oxide and the optical brightener are then added to this second mixture, along with any dye system, additives, aluminium oxide and porous silica. The mixtures can be made either from liquid resins using a speed-mixer or a paddle mixer. The resulting mixture can then be shaped by extrusion. The mixtures can also be made in a twin-screw extruder or in a high-speed mixer for the manufacture of thermoplastic mixtures and transformation into granules, which can be reused for injection moulding.

The method for manufacturing an item coated with the photoluminescent material consists of depositing a coating on the substrate using techniques such as screen printing, pad printing or spray coating.

Tests to produce samples as a whole from the photoluminescent material were carried out by adding 5% by weight, based on the total weight of the photoluminescent material, of yttria-stabilised zirconia to an epoxy resin with a filler content of 60% by weight of photoluminescent pigments of Eu²⁺,Dy₃₊:SrAl₂O₃. The samples were observed under a D65 light booth. In parallel, tests were carried out with TiO₂, ZnO, BaSO₄, CaCO₃, SiO₂ and Al₂O₃ with the same base material.

Tests were also carried out with 5% by weight of yttria-stabilised zirconia combined with 0.25%, 2.5% and 5% by weight of Al₂O₃.

Tests were also carried out with 5% by weight of yttria-stabilised zirconia combined with 0.2% by weight of porous silica.

The material was shaped by vacuum casting.

These tests showed that the best compromise between whiteness and intensity of phosphorescent emission is obtained with yttria-stabilised zirconia, with an increasing level of whiteness in the presence of Al₂O₃ depending on the quality of the white to be achieved in visible colour.

Tests with porous silica showed a 20% increase in luminescence properties after 10 minutes, with the luminescence properties being measured in accordance with ISO 17514-2003.

1. A photoluminescent material comprising, by weight, between 19.3% and 54.3% of a polymer matrix, between 45% and 80% of a photoluminescent compound, between 0.5% and 15% of a zirconium oxide, between 0.2% and 7% of an optical brightener and between 0% and 5% of an aluminium oxide, between 0% and 0.3% of a porous silica, a dye system and additives, the total percentage of the dye system and additives being between 0% and 15%.

2. The photoluminescent material according to claim 1, wherein the polymer matrix is present in a percentage of between 28.5% and 48.5%, the photoluminescent compound is present in a percentage of between 50% and 70%, the zirconium oxide is present in a percentage of between 1% and 10% and the optical brightener is present in a percentage of between 0.5% and 5%.

3. The photoluminescent material according to claim 1, wherein aluminium oxide is present in a percentage of between 0.5% and 5% Al₂O₃.

4. The photoluminescent material according to claim 1, wherein the porous silica is present in a percentage of between 0.01% and 1%.

5. The photoluminescent material according to claim 1, wherein the porous silica is derived from diatom skeletons.

6. The photoluminescent material according to claim 1, wherein the photoluminescent compound comprises a pigment which is a rare earth-doped alkaline earth aluminate derivative.

7. The photoluminescent material according to claim 6, wherein the pigment is a Europium- and Dysprosium-doped alkaline-earth aluminate derivative of the formula Sr(x)Al(y)O(z):Eu²⁺,Dy³⁺.

8. The photoluminescent material according to claim 7, wherein the pigment is Sr₄Al₁₄O₂₅:Eu²⁺, Dy₃₊ and/or SrAl₂O₄:Eu²⁺,Dy³.

9. The photoluminescent material according to claim 6, wherein the photoluminescent compound consists of said pigment encapsulated in an organic or mineral, transparent shell.

10. The photoluminescent material according to claim 1, wherein the zirconium oxide is stabilised, preferably with yttria.

11. The photoluminescent material according to claim 1, wherein the polymer matrix comprises one or more resins from the acrylic family, the polyamide family, the polyolefin family, the epoxy family, the polyurethane family, the fluoroelastomer family and silicones.

12. The photoluminescent material according to claim 9, wherein the organic transparent shell comprises one or more resins from the acrylic family, the polyamide family, the polyolefin family, the epoxy family, the polyurethane family, the fluoroelastomer family and silicones, and in that the mineral transparent shell comprises silica.

13. The photoluminescent material according to claim 6, wherein the photoluminescent compound comprises pigments of various particle sizes.

14. The photoluminescent material according to claim 13, wherein the pigments have at least a first particle size range centred around a diameter D1 of between 500 μm and 10 μm and a second particle size range centred around a diameter D2 of between 10 μm and 500 μm.

15. The photoluminescent material according to claim 1, wherein the optical brightener is a stilbene derivative containing a sulphonate group.

16. An item produced from or coated with said photoluminescent material according to claim 1.

17. The item according to claim 16, wherein the item is a timepiece component.
